(19) United States
(12) Patent Application Publication
(10) Pub. No.: US 2024/0319380 A1
(43) Pub. Date: Sep. 26, 2024

(54) SYSTEMS AND METHODS FOR DETERMINING VEHICLE POSITION

(71) Applicant: Ground Transportation Systems Canada Inc., Toronto (CA)

(72) Inventors: Bojan SUBASIC, Toronto (CA); Alon GREEN, Toronto (CA)

(21) Appl. No.: 18/614,560

(22) Filed: Mar. 22, 2024

Related U.S. Application Data
(60) Provisional application No. 63/491,928, filed on Mar. 23, 2023.

(51) Int. Cl. G01S 19/07; G01S 19/43; G01S 19/50

(52) U.S. Cl. CPC G01S 19/07; G01S 19/43; G01S 19/50

(57) ABSTRACT

A system includes a base station that includes an RTK base unit and a static RTK rover unit, the RTK base unit and the static RTK rover unit being at a same fixed location; a GPS antenna corresponding to the base station and being at a first position; and a management center in communication with the base station. The RTK base unit includes a first GPS receiver coupled to the GPS antenna, the static RTK rover unit includes a second GPS receiver coupled to the GPS antenna, the static RTK rover unit is configured to determine its position as a second position according to GPS information received via the GPS antenna and RTK correction information received from the RTK base unit, and the management center is configured to determine whether the RTK correction information is valid.

### PRIORITY CLAIM

The present application claims the priority of U.S. Provisional Application No. 63/491,928, filed Mar. 23, 2023, which is incorporated herein by reference in its entirety.

### BACKGROUND

A vehicle position can be determined by localization using a transponder interrogator installed on the vehicle and transponder tags installed on a track such as a path, guideway, rail, roadway, or the like. Localization can be performed using ultra-wideband (UWB) radio tags and anchors, cameras, or the like. Such approaches can involve a relatively dense installation of wayside elements along the track, e.g., every 100 meters (m), and can involve providing power to the wayside elements such that a large number of wayside elements are provided with power. Additionally, the positional accuracy of such approaches can be inconsistent and insufficient for some needs.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a schematic diagram of a system architecture, in accordance with some embodiments.

FIG. 1B is a schematic diagram of a vehicle unit, in accordance with some embodiments.

FIG. 1C is a schematic diagram of a base station, in accordance with some embodiments.

FIG. 1D is a schematic diagram of a system architecture, in accordance with some embodiments.

FIG. 1E is a schematic diagram of a system architecture, in accordance with some embodiments.

FIG. 1F is a schematic diagram of a positioning system, in accordance with some embodiments.

FIG. 2 is a logic diagram of supervision of base station health, in accordance with some embodiments.

FIG. 3 is a logic diagram of supervision of position and speed for an onboard GPS, in accordance with some embodiments.

FIG. 4 is a schematic diagram of supervision of position reported by an onboard GPS receiver using a map, in accordance with some embodiments.

FIG. 5 is a schematic diagram of an arrangement of redundant base stations, in accordance with some embodiments.

FIG. 6 is a schematic diagram of a processing system, in accordance with some embodiments.

FIG. 7 is a flowchart of a method of determining vehicle position, in accordance with some embodiments.

FIG. 8 is a flowchart of a method of determining vehicle position, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

One or more embodiments relate to communication-based train control (CBTC), which is applicable to vehicles such as rail vehicles such as trains, road vehicles such as cars, or the like, which operate with some level of automation and are in some cases autonomous.

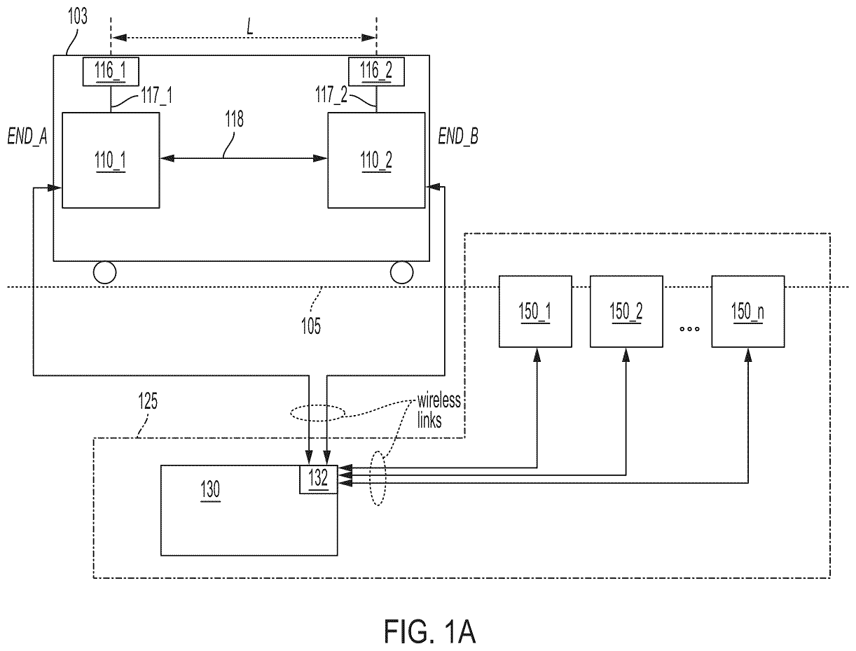

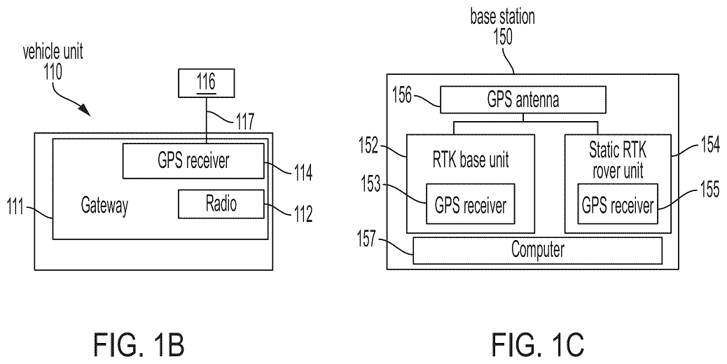

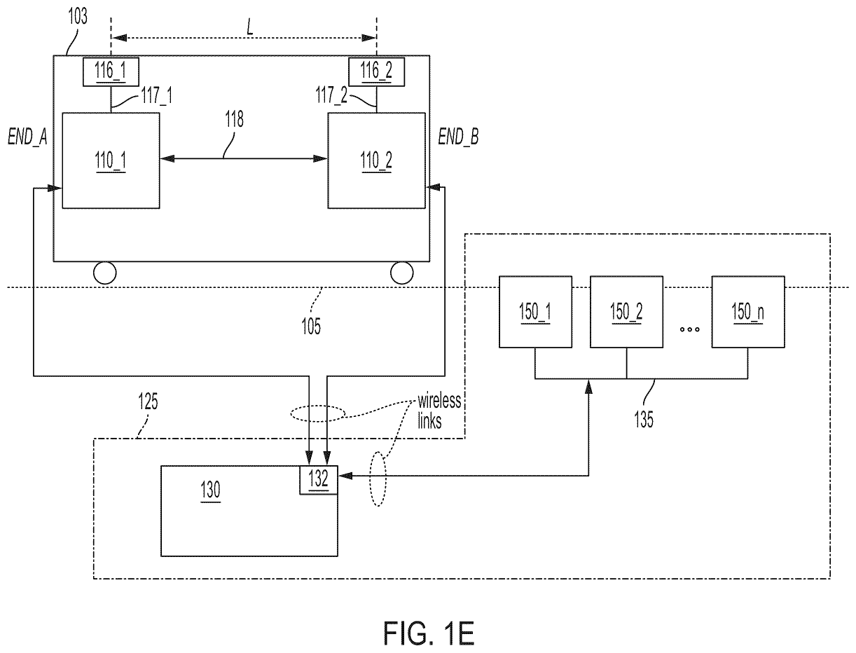

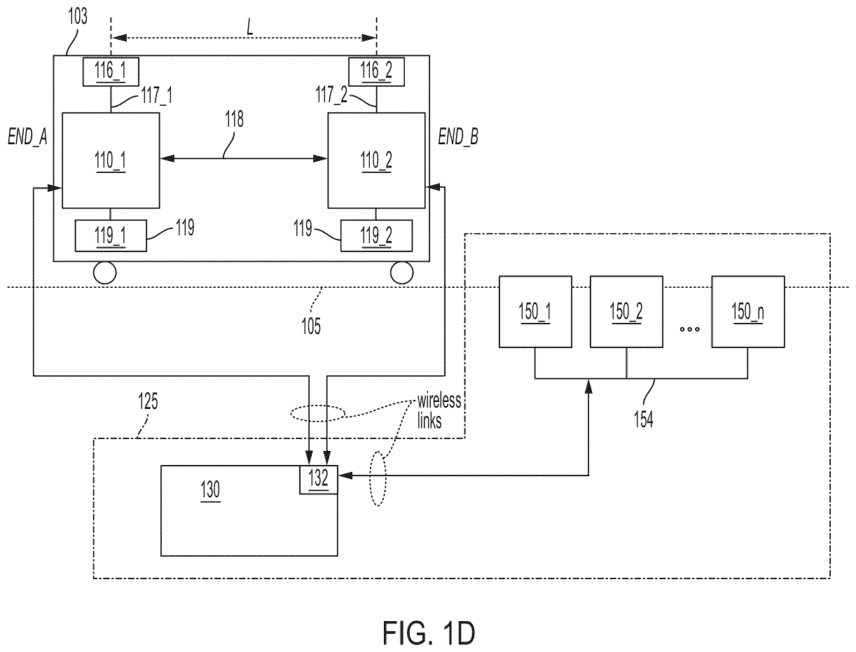

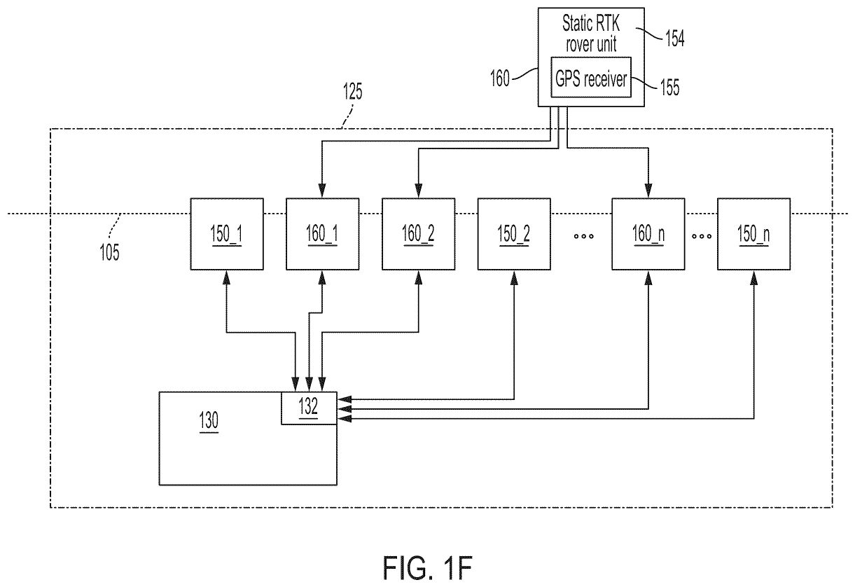

FIG. 1A is a schematic diagram of a system architecture, in accordance with some embodiments. FIG. 1B is a schematic diagram of a vehicle unit, in accordance with some embodiments. FIG. 1C is a schematic diagram of a base station, in accordance with some embodiments. FIG. 1D is a schematic diagram of a system architecture, in accordance with some embodiments. FIG. 1E is a schematic diagram of a system architecture, in accordance with some embodiments.

Some embodiments relate to a positioning system for a vehicle on a track. In FIG. 1A, a vehicle 103 on a track 105 is shown as an example. In some embodiments, the vehicle is a rail vehicle and the track is a rail. In some embodiments, a single rail is used. In some embodiments, multiple rails are used, e.g., two rails in parallel. In some embodiments, the rail vehicle is a single car. In some embodiments, the rail vehicle is a series of cars coupled together, e.g., mechanically coupled. In some embodiments, the vehicle is an automobile and the track is a roadway. In some embodiments, a human driver is present in the vehicle and exerts some control over the vehicle. In some embodiments, a human driver is located outside of the vehicle, e.g., in a remote control center or other place separate from the vehicle, and exerts some control over the vehicle via a remote link such as a wireless network. In some embodiments, the vehicle operates autonomously, i.e., without real-time human input. In some embodiments, the vehicle operates autonomously with respect to at least one function, e.g., speed and/or direction. In some embodiments, the vehicle operates completely autonomously. In some embodiments, autonomous operation includes real-time human oversight, e.g., with a person in the vehicle to oversee the autonomous operation and to take control if desired or needed, or with a person remote (separate) from the vehicle to oversee the autonomous operation and to take control if desired or needed. Various embodiments are described using a train as an example of the above-described vehicles.

In FIG. 1, the vehicle 103 includes a first end END_A and a second end END_B. In some embodiments, the direction of travel of the vehicle 103 changes, such that the first end END_A leads the second end END_B, or the first end END_A trails the second end END_B. In some embodiments, the first end END_A and the second END_B are ends of a single car of a train. In some embodiments, the first end END_A is an end of a first car of a train and the second END_B is an end of a second car of a train. In some embodiments, one or more cars are between the first end END_A and the second end END_B. In some embodiments, the first end END_A and/or the second end END_B is located away from a physical outermost point of the vehicle 103, e.g., such that one or more cars of a train are on each side of the first end END_A and/or the second end END_B.

The vehicle 103 is equipped with an onboard vehicle unit 110. In FIG. 1A, the vehicle 103 is equipped with an onboard vehicle unit 110 at each end, such that the vehicle 103 includes a first vehicle unit 110_1 at the first end END_A and a second vehicle unit 110_2 at the second end END_B. Herein, references to “onboard” refer to components, devices, or the like that are coupled to or attached to the vehicle 103 and travel with the vehicle 103. A component or device that is onboard moves in concert with the vehicle 103.

An onboard component or device is distinguished from a fixed, static, stationary, or wayside component or device, which is separate from the vehicle 103 and does not move in concert with the vehicle 103. Herein, the fixed, stationary, or wayside component or device may be referred to as not onboard.

Referring to FIG. 1B, in some embodiments, the vehicle unit 110 includes an onboard gateway 111, which includes an onboard GPS receiver 114 and is operable to obtain a GPS signal (using the onboard GPS receiver 114) and to communicate wirelessly (using the onboard gateway 111) with one or more other elements (onboard and/or not onboard) of a train control system, e.g., a CBTC system and/or a positioning system 125 according to embodiments described herein. In some embodiments, the vehicle unit 110 or the onboard gateway 111 includes or constitutes a mobile RTK rover unit that receives RTK correction information from a base station.

Some embodiments are described herein as using GPS as a form of global navigation satellite system (GNSS). However, GPS is used as an example, and other forms of GNSS are used in other embodiments.

The onboard GPS receiver 114 is operable to perform a real time kinematic (RTK) positioning operation, either alone or in combination with one or more other components of the vehicle unit 110. In some embodiments, the onboard GPS receiver 114 is operable in an RTK rover mode of operation, and may be referred to as a vehicle rover or train rover. In some embodiments, the onboard GPS receiver 114 includes or constitutes a mobile RTK rover unit that receives RTK correction information from a base station.

The onboard GPS receiver 114 is coupled to an onboard GPS antenna 116 using a connector 117 such as a coaxial cable (coax) or the like. In FIG. 1A, the first vehicle unit 110_1 includes a first onboard GPS antenna 116_1, the second vehicle unit 110_2 includes a second onboard GPS antenna 116_2, and the two onboard GPS antennas 116_1, 116_2 are separated by a known distance I.

The onboard gateway 111 includes a communications radio 112 that communicates with another onboard radio and/or a not onboard radio using one or more of 4G, 5G, Long-Term Evolution (LTE), Wi-Fi, Bluetooth, or the like. The onboard gateway 111 is operable to perform one or more of a communication operation, an RTK positioning operation, a management operation, a monitoring operation, and/or a configuration operation, one or more of which can be implemented as code, instructions, or software executed on the onboard gateway 111, e.g., as a software, hardware, and/or firmware stack. The onboard gateway 111 is coupled to an onboard communications antenna.

The vehicle unit 110 performs a positioning operation. The positioning operation executes on the onboard gateway 111 in some embodiments, and executes on a separate, onboard computer in other embodiments.

The vehicle unit 110 communicates with another vehicle unit 110 (e.g., the first vehicle unit 110_1 communicates with the second vehicle unit 110_2) and/or a positioning system 125 according to embodiments described herein. An onboard network 118 is shown in FIG. 1A as connecting the first vehicle unit 110_1 with the second vehicle unit 110_2. In other embodiments, a common onboard system, e.g., a common onboard radio system, is used for communications to/from the first and second vehicles unit 110_1, 110_2 and the positioning system 125.

In some embodiments, the positioning system 125 is included in a CBTC system. In some embodiments, the positioning system 125 is a standalone system. The positioning system 125 includes a management center 130 and an RTK-enabled base station 150 or a plurality of the base stations 150 (e.g., first base station 150_1, second base station 150_2, . . . , n^{th} base station 150_n). In FIG. 1A, the management center 130 communicates with the base station 150 via a wireless link such as a radio link. In FIG. 1A, the management center 130 includes a radio 132 for communications. In some embodiments, the management center 130 communicates with the base station 150 via a physical link, e.g., a wired link, or a combination of wireless links, physical links, optical links, or the like.

In some embodiments, the management center 130 communicates directly with each base station 150 of a plurality of the base stations 150. In some embodiments, as shown in FIG. 1D, several base stations 150 (e.g., first base station 150_1, second base station 150_2, . . . , n^{th} base station 150_n) are interconnected by a wayside communications network 135, and the management center 130 communicates with the wayside communications network 135.

The management center 130 also communicates with the vehicle unit 110 via a wireless link. In some embodiments, the management center 130 communicates with the vehicle unit 110 via a combination of wireless links, physical links, optical links, or the like. In some embodiments, the positioning system 125 communicates with the first vehicle unit 110_1 and the second vehicle unit 110_2. In some embodiments, the positioning system 125 preferentially communicates or only communicates with one of the vehicle units 110, e.g., with the first vehicle unit 110_1 or the second vehicle unit 110_2.

The base station 150 is static at a known position POS1. Herein, a known position (e.g., the known position POS1) is established by other than the positioning system 125, e.g., the known position POS1 is established by survey (i.e., land survey) during initial base station installation. In some embodiments, there are multiple base stations 150 (e.g., first base station 150_1, second base station 150_2, . . . , n^{th} base station 150_n), each having a corresponding known position (e.g., POS1_1 for first base station 150_1, POS1_2 for second base station 150_2, . . . , POS1_n for n^{th} base station 150_n) established by survey during initial installation of the base stations. In some embodiments, the base station 150 is located along a wayside of a track 105 that the vehicle 103 can operate on, as shown schematically in FIG. 1A.

In FIG. 1C, the base station 150 includes a static (i.e., fixed location) RTK base unit 152 that includes a first GPS receiver 153. The RTK base unit 152 is static at the known position POS1 of the base station 150. The RTK base unit 152 supplies RTK correction information.

The base station 150 also includes a static (i.e., fixed location) RTK rover unit 154 that includes a second GPS receiver 155. The collocated static RTK rover unit 154 is static at the known position POS1 of the base station 150. The collocated static RTK rover unit 154 may be referred to herein as a local RTK rover.

The RTK base unit 152 is collocated with the static RTK rover unit 154 at the known position POS1 of the base station 150. In FIG. 1C, the RTK base unit 152 and the collocated static RTK rover unit 154 share a same physical GPS antenna 156. In some embodiments, establishing the known position POS1 of the base station 150 involves establishing the position of the GPS antenna 156 (by other than the positioning system 125, e.g., by survey (i.e., land survey) of the GPS antenna 156 during initial base station installation), such that the known position POS1 is the established position of the GPS antenna 156. That is, in some embodiments, the position of the base station 150 is, more precisely, the position of the GPS antenna 156 and, correspondingly, the positions of the RTK base unit 152 and the collocated static RTK rover unit 154 are, more precisely, the position of the GPS antenna 156 that they share. Accordingly, under ideal circumstances (i.e., without an error in measurement), the RTK base unit 152 and the collocated static RTK rover unit 154 sharing the GPS antenna 156 will report identical positions, both equal to the known position POS1.

The collocated static RTK rover unit 154 is configured to determine its position as a second position POS2 according to GPS data and RTK correction data that both correspond to the known position POS1. The static RTK rover unit 154 is configured to receive the RTK correction data from the RTK base unit 152.

In FIG. 1C, the collocated static RTK rover unit 154 and the RTK base unit 152 collocated within the same base station 150 share the same GPS antenna 156 such that, in normal situations, the collocated static RTK rover unit 154 should resolve its own position POS2 to be equal to the known position POS1 of the base station 150. The management center 130 is configured to compare the known position POS1 and the second position POS2.

The base station 150 includes a computer 157. In some embodiments, the computer 157 is operable as a communication gateway.

In some embodiments, the positioning system 125 is under closed-loop control by a dedicated management system, e.g., executing on the management center 130, that ensures high integrity of the position solution along the track. In some embodiments, a method to determine a position of the vehicle 103 (i.e., positioning) uses the onboard GPS receiver 114 installed on the vehicle 103, the collocated static RTK rover unit 154 installed on a wayside at the known position POS1, the RTK base unit installed on the wayside at the known position POS1, and a map. Some embodiments provide for vital (high safety integrity) and high accuracy train positioning without a dense installation of wayside or trackside equipment.

A safety-critical application or system is rated Safety Integrity Level (SIL) 4 (SIL4). For a system to be rated as SIL4, the system provides demonstrable on-demand reliability, and techniques and measurements to detect and react to failures that may compromise the system's safety properties. SIL4 is based on International Electrotechnical Commission's (IEC) standard IEC 61508, and EN standards 50126 and 50129. For an SIL4 system, the probability of failure per hour ranges from 10-8 to 10-9. Safety systems that are not required to meet a safety integrity level standard are referred to as non-SIL. In one or more embodiments described herein, the disclosed systems meet SIL4.

In some embodiments, communication links in this system regardless of the type of communication (e.g., 4G, 5G, LTE, WiFi, Bluetooth, or the like) will use a virtual private network (VPN) tunneling approach to ensure authenticity and integrity of all service flows that exist in the system. In some embodiments, such VPN tunneling uses IPSec, OpenVPN, WireGuard, TLS, DTLS, or another suitable form of secure and encrypted communication links between the onboard and wayside system elements.

In some embodiments, a position function is performed by the onboard gateway 111, as shown in FIG. 1B. In some embodiments, the position function is performed by a separate computer, e.g., a position computer 119), as shown in FIG. 1E. In the case that the position function is performed by the position computer 119, the position computer 119 communicates with the onboard gateway 111, e.g., by ethernet or other wired or wireless network.

In the case of the position function residing within the onboard gateway 111 and to ensure proper separation (isolation) from other function of the onboard gateway 111, in some embodiments the position function is implemented under a different process and/or a different container from the gateway process and/or container.

In the embodiments shown in FIGS. 1A-1E, the vehicle 103 is equipped with two sets (one per each end END_A, END_B) of the onboard gateway 111, which includes: (a) the onboard GPS receiver 114 operating in an RTK rover mode of operation and connected to the onboard GPS antenna 116, and (b) the communication radio 112, which is operable over one or more of, e.g., 4G, 5G, LTE, WiFi, Bluetooth, or the like using a communication antenna. The onboard gateway 111 runs communication protocols, an RTK stack, and management, monitoring. and configuration stacks. A positioning processing function is implemented on a separate computer (as in FIG. 1E), or runs (e.g., as a separate process, container, or VM) on the onboard gateway 111 itself (as in FIGS. 1A and 1D).

In FIG. 1A, the base stations 150 are distributed along the track 105, which is a guideway or rails in some embodiments. In FIG. 1A, each base station 150 includes: (a) the computer 157, (b) the RTK base unit 152 (including the GPS receiver 153 and operating in RTK base station mode), (c) the collocated static RTK rover unit 154 (including the GPS receiver 155 and operating as a local RTK rover) co-located with the RTK base unit 152, and (d) the GPS antenna 156, which in some embodiments is a high-quality antenna, shared by the RTK base unit 152 and the collocated static RTK rover unit 154. In some embodiments, the placement of the GPS receivers 153, 155 is varied, e.g., internal to or external to the base station 150, while still sharing the GPS antenna 156.

In some embodiments, the computer 157 of the base station 150 is responsible for configuration, management, and monitoring of the RTK base unit 152 and the collocated static RTK rover unit 154. In some embodiments, the computer 157 of the base station 150 provides RTK correction messages to the onboard GPS receiver 114 (vehicle rover).

The RTK base unit 152 and the collocated static RTK rover unit 154 collocated within the same base station 150 share the same GPS antenna 156 such that, in normal situations, the collocated static RTK rover unit 154 should resolve its own position POS2 to be equal to the base station 150 surveyed position POS1 achieved during initial base station installation.

The computer 157 of the base station 150 raises alarms to the management center 130 in events such as: (a) GPS is not locked for base station GPS receiver 153, (b) GPS errors and RTK errors for the collocated static RTK rover unit 154 (local rover), (c) out-of-bound temperature, voltage, and/or antenna voltage standing wave ratio (VSWR) indications, and/or (d) detection of spoofing and/or interference. In some embodiments, the alarms will inhibit transmission of RTK correction messages from the RTK base unit 152 to any static or moving RTK rovers.

FIG. 1F is a schematic diagram of a positioning system, in accordance with some embodiments.

In FIG. 1F, the positioning system 125 includes a non-collocated (stand-alone) static RTK rover unit 160 disposed in plural along the track 105 (shown as a first stand-alone static RTK rover unit 160_1, a second stand-alone static RTK rover unit 160_2, . . . , and an n^{th} stand-alone static RTK rover unit 160_n). The second stand-alone static RTK rover unit 160 is not part of or collocated with a base station 150. The stand-alone static RTK rover unit 160 is in communication with the management center 130. In some embodiments, stand-alone static RTK rover unit 160 communicates via the wayside communications network 135.

In some embodiments, the stand-alone static RTK rover unit 160 includes a gateway or computer operating as a gateway or to perform gateway functions, which in some embodiments is identical to the onboard gateway 111 or the computer 157 of the base station 150. In some embodiments, a GPS rover receiver is integrated in the gateway of the stand-alone static RTK rover unit 160. In some embodiments, a GPS rover receiver is externally connected to the gateway of the stand-alone static RTK rover unit 160. In some embodiments, the stand-alone static RTK rover unit 160 includes a GPS antenna and one more communication links for 4G, 5G, LTE, WiFi, Bluetooth, or the like.

In some embodiments, other than not being part of or collocated with a base station 150, the stand-alone static RTK rover unit 160 is identical to the collocated static RTK rover unit 154.

In some embodiments, the stand-alone static RTK rover units 160 are installed in critical places along the track 105 and their known positions are stored in a map or database. In some embodiments, the known positions of the stand-alone static RTK rover units 160 are determined by land survey during initial installation. The stand-alone static RTK rover units 160 report their positions based on RTK correction information (e.g., from the RTK base unit 152), and integrity is checked by comparison of reported positions to the corresponding known positions stored in the map or database. In some embodiments, integrity of the positions reported by the stand-along static RTK rover units 160 are checked by the management center 130.

In FIGS. 1A, 1D, 1E, and 1F, all elements of the positioning system 125 are connected to or in communication with the management center 130, and the management center 130 has a full view of and status of all GPS components in the positioning system 125.

In some embodiments, position and speed values from the RTK base unit 152 and the static RTK rover unit 154 (which are collocated within the same base station 150) are sent to the management center 130, which performs one or more of the following supervisions for a given base station 150:
1. Check that, for the base station 150, the position reported by the RTK base unit 152 is consistent, within a defined tolerance, with the position reported by the collocated static RTK rover unit 154.
2 Check that, for the base station 150, the RTK base unit 152 reports its speed as zero (0), within a defined tolerance.
3. Check that, for the base station 150, the static RTK rover unit 154 reports its speed as zero (0), within a defined tolerance.
4. Check that, for the base station 150, the position reported by the RTK base unit 152 and the position reported by the collocated static RTK rover unit 154 are the same as the known (i.e., surveyed or reference) position of the GPS antenna shared by the RTK base unit 152 and the static RTK rover unit 154, within a defined tolerance.
5. Set a health status of the base station 150 to ‘healthy’ if all the above checks 1, 2, 3, and 4 successfully pass; otherwise, set the health status of the base station 150 to ‘unhealthy’.
6. Report health of the base station 150 to vehicle(s) 103 and other connected systems.

In some embodiments, a defined tolerance for a position reported by GPS is ±5 cm in latitude, longitude, and altitude. In some embodiments, a comparison of two positions reported by GPS is within a defined tolerance if the difference in the two positions is equal to or less than ±10 cm in latitude, longitude, and altitude. In some embodiments, a defined tolerance for a speed reported by GPS for a fixed or static GPS antenna is ±2 cm/sec.

In some embodiments, the vehicle unit 110 is configured to receive correction information from the base station 150 and to use the correction information from the base station 150 only when the health status of the base station 150 is ‘healthy’. In some embodiments, the management center 130 instructs the vehicle unit 110 not to use correction information from the base station 150 when the health status of the base station is ‘unhealthy’. In some embodiments, the vehicle unit 110 is configured to receive correction information from the base station 150 via the management center 130 and the management center is configured to transmit the correction information to the vehicle unit 110 only when the health status of the base station 150 is ‘healthy’. In some embodiments, the vehicle unit 110 is simultaneously in a zone of coverage of two base stations 150, i.e., a first base station 150_1 and a second base station 150_2, and the vehicle unit 110 determines its position using correction information from the second base station 150_2 when the health status of the first base station 150_1 is ‘unhealthy’.

The stand-alone static RTK rover unit 160 receives RTK correction messages from the base station(s) 150 and applies the corrections to the GPS receiver 155. The stand-alone static RTK rover unit 160 monitors RTK status and key performance indicator (KPI) or multiple KPIs of the GPS, and compares its resolved position against its known position.

The stand-alone static RTK rover unit 160 reports status and KPI(s) to the management center 130, and raises alarms or sends notifications to the management center 130 in events of:
1. GPS is not locked,
2. GPS errors and/or RTK errors for the stand-alone static RTK rover unit 160 are outside of a defined tolerance,
3. the resolved position differs from the known position by more than a defined tolerance,
4. temperature, voltage, antenna VSWR, and/or other health indicators are outside of a defined tolerance, and/or
5. spoofing and/or interference is detected.

Similarly, for the vehicle 103, in some embodiments the onboard gateway 111 is a device with a full management and configuration plane. In some embodiments, the onboard gateway uses secure protocol implementations NETCONF over SSH or TLS. In some embodiments, the onboard gateway 111 supports different forms of wireless communications, e.g., with integrated radio module capability or externally-connected radio modem(s). In some embodiments, regardless of the type of wireless link, the wireless link is always under full configuration, management, and operational monitoring of the onboard gateway 111. In some embodiments, the wireless link is not a standalone and un-managed connectivity solution.

The onboard gateway 111 communicates with the base station(s) 150 and receives RTK correction messages from the base stations 150 (e.g., from the RTK base unit 152) that are input to the onboard GPS receiver 114 (onboard RTK rover). In some embodiments, the onboard gateway 111 includes a built-in GPS RTK receiver or has an external GPS RTK receiver connected thereto. The onboard gateway 111 monitors GPS status, and reports statuses, KPIs, and resolved position (which are RTK-corrected) that are input to the position function (which runs on, e.g., the onboard gateway 111 (e.g., as a standalone process, container, VM, or the like) or the position computer 119).

In some embodiments, the position function accepts the resolved position from the onboard GPS receiver 114 if one, some, or all of the following conditions are fulfilled:
1. The base station 150 used to correct the GPS position estimation has a status of ‘healthy’ (or ‘trusted’).
2. The onboard GPS receiver 114 provides a position that is consistent, within a defined tolerance, with a map spline (representing the centerline between the two running rails).
3. The onboard GPS receiver 114 provides a speed that is consistent, within a defined tolerance, with a speed the position computer speed estimation based on a non-GPS speed sensor such as an inertial measurement unit (IMU),
4. The onboard GPS receiver 114 provides a position that is consistent, within a defined tolerance, with one or more previous positions and speeds of the vehicle 103.
5. The onboard GPS receiver 114 of the first vehicle unit 110_1 provides a position for the first end END_A of the vehicle 103 that is the known distance L (within a defined tolerance) from a position provided by the onboard GPS receiver 114 of the second vehicle unit 110_1 for the second end END_B of the vehicle 103.

For the above condition no. 5 (relating to positions of ends END_A and END_B), the corresponding onboard GPS receivers 114 can be located at places on the vehicle 103 that are not outermost ends of the vehicle 103, as described above.

In some embodiments, the position function requires the above condition no. 5 to be fulfilled only for a cold start position initialization (position of the vehicle 103 is unknown), whereas the position function does not require condition no. 5 to be fulfilled once a position of the vehicle 103 has been established.

In some embodiments, integrity of a GPS-based position and/or speed of the vehicle 103 is enhanced using the base station 150 (including the collocated RTK base unit 152 and static RTK rover unit 154 sharing same GPS antenna) and a map.

In some embodiments, the management center 130 checks to see that the speed reported by the RTK base unit 152 matches (within a defined tolerance) the speed reported by the collocated static RTK rover unit 154, and/or checks that both speeds are zero (0) (within a defined tolerance). This helps to ensure full health and operational conditions of base station(s) 150, and helps to ensure that RTK corrections from the base station(s) 150 are valid and acceptable for determining the position and/or speed of the vehicle 103. In some embodiments, the management center 130 sets a health status of the base station 150 to ‘unhealthy’ when RTK correction information from the base station 150 is determined to be invalid. In some embodiments, the management center 130 determines the RTK correction information from the base station 150 to be valid or invalid.

In some embodiments, the management center 130 determines the RTK correction information to be invalid if the speed reported by the RTK base unit 152 does not match (within a defined tolerance) the speed reported by the collocated static RTK rover unit 154. In some embodiments, the management center 130 determines the RTK correction information to be invalid if the speed reported by the RTK base unit 152 is greater than zero (0) by more than a defined tolerance. In some embodiments, the management center 130 determines the RTK correction information to be invalid if the speed reported by the static RTK rover unit 154 is greater than zero (0) by more than a defined tolerance.

In some embodiments, integrity of a GPS-based position and/or speed of the vehicle 103 is enhanced using the wayside communications network 135 of the collocated static RTK rover units 154 and/or the stand-alone static RTK rover units 160 installed along the track 105 at predefined static coordinates, i.e., known (surveyed) positions. In some embodiments, positions reported by the collocated static RTK rover units 154 and/or the stand-alone static RTK rover units 160 are only accepted (e.g., by the management center 130) if the reported positions match (within a defined tolerance) the predefined static coordinates, i.e., known (surveyed) positions, which helps to ensure the health and accuracy of the positioning system 125.

In some embodiments, the positioning system 125 operates in a closed-loop control operational mode, in which each node (e.g., each base station 150 or stand-alone static RTK rover unit 160) performs internal checks and balances using available information from the corresponding GPS receivers 153, 155, and validate the currently-resolved GPS position against predefined static coordinates, i.e., known (surveyed) positions.

In some embodiments, the onboard position function (run by, e.g., the onboard gateway 111 and/or position computer 119) checks that the resolved position reported by the onboard GPS receiver 114 matches (within a defined tolerance) a spline for the track 105 on a map.

In some embodiments, the onboard position function checks that the resolved position reported by the onboard GPS receiver 114 is consistent with a previous resolved position and GPS-derived speed of the vehicle 103. In other embodiments, the onboard position function checks that the resolved position reported by the onboard GPS receiver 114 is consistent with a previous resolved position and non-GPS-derived speed of the vehicle 103 from a non-GPS-derived speed measurement, such as a speed measurement from an IMU.

In some embodiments, for a cold start in which the position of the vehicle 103 is unknown, the onboard position function checks that two (independent) onboard GPS receivers 114 (e.g., in the first vehicle unit 110_1 and the second vehicle unit 110_2) provide resolved positions that are consistent (within a defined tolerance) with the known distance/between their associated GPS antennas (e.g., onboard GPS antennas 116_1 and 116_2).

In some embodiments, a system and method to determine a position and/or a speed of the vehicle 103 use the vehicle unit 110 having the onboard (moving) GPS receiver 114 operable to perform a real-time kinematic (RTK) positioning operation, the base station 150, the stand-alone static RTK rover unit 160, and a map. The system and method check that the RTK base unit 152 and the collocated static RTK rover unit 154 (collocated within the same base station 150 and sharing a common GPS antenna 156) provide consistent speeds (zero (0) speeds) and positions (within corresponding defined speed and position tolerances), and check that the reported positions are consistent (within a defined tolerance) of a known position (or reference position), e.g., as established by survey (i.e., land survey) during initial base station installation.

In some embodiments, a system uses management center supervision and/or onboard supervision, as described in the following.

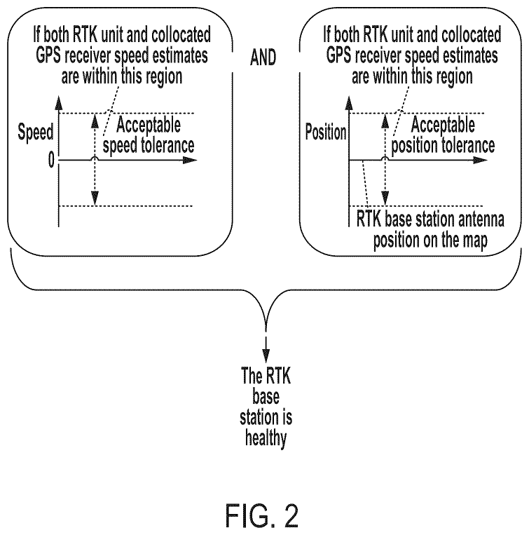

FIG. 2 is a logic diagram of supervision of base station health, in accordance with some embodiments.

In some embodiments, management center supervision is implemented in the management center 130. In some embodiments, the management center 130 performs supervision by checking that the position and speed estimates of the RTK base unit 152 and the static RTK rover unit 154 (which are collocated within the same base station 150), are consistent within a defined tolerance. In some embodiments, the management center 130 determines the status of the base station 150 to be healthy (and thus trusted) if it is determined that the position and speed estimates of the RTK base unit 152 and the collocated static RTK rover unit 154 are consistent within the defined tolerance, whereas the management center 130 determines the status of the base station 150 to be unhealthy (and thus untrusted) if it is determined that the position and speed estimates of the RTK base unit 152 and the collocated static RTK rover unit 154 are not consistent within the defined tolerance.

Further to the above, referring to FIG. 2, in some embodiments a positioning system 125 supervises, e.g., using the management center 130, position and speed values reported by the base station 150. In some embodiments, a plurality of base stations 150 are included in the positioning system 125, and supervision is performed for each base station 150. In some embodiments, each base station 150 is assigned a status of healthy or unhealthy (or trusted or untrusted). In some embodiments, the status of the base station 150 is set by the management center 130. In some embodiments, the management center 130 performs supervision of a base station 150 by performing one or more of the following two checks:
1. The speeds reported by the RTK base unit 152 and the static RTK rover unit 154 (which are collocated within the same base station 150), are consistent within a defined tolerance (indicated in (a) in FIG. 2).
2. The positions reported by the RTK base unit 152 and the static RTK rover unit 154 (which are collocated within the same base station 150), are consistent within a defined tolerance (indicated in (b) in FIG. 2).

In some embodiments, the management center 130 trusts (e.g., assigns a status of healthy or trusted, indicating, e.g., that the base station 150 can be utilized for vehicle control) the speed and position reported by the base station 150 if one or more of the above two checks are true. In some embodiments, the management center 130 trusts the speed and position reported by the base station 150 only if all two of the above two checks are true.

In some embodiments, a trusted status indicates that the device, data, system, or the like that is trusted will be used to determine position of the vehicle 103 for vehicle control or the like, where as an untrusted status indicates that the device, data, system, or the like that is no trusted will not be used to determine position of the vehicle 103 for vehicle control or the like.

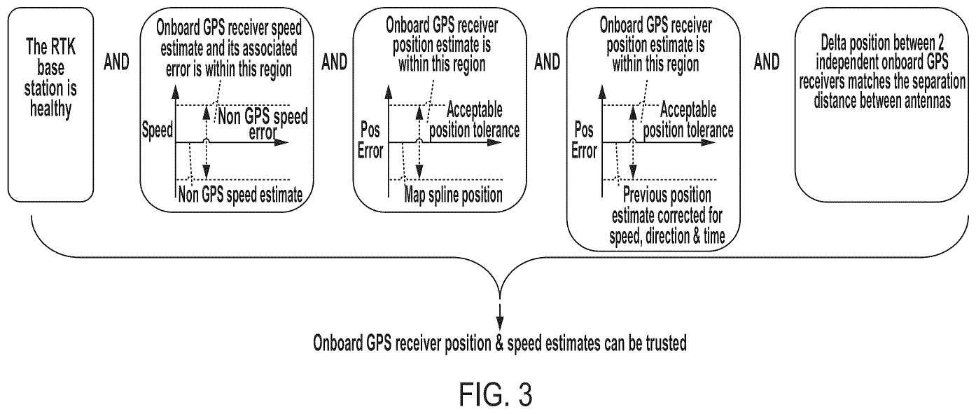

FIG. 3 is a logic diagram of supervision of position and speed for an onboard GPS, in accordance with some embodiments.

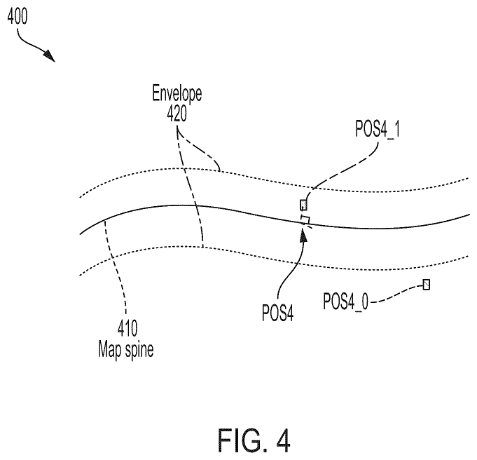

In some embodiments, onboard supervision is implemented in the onboard gateway 111 and/or position computer 119. In some embodiments, onboard supervision by the onboard gateway 111 and/or position computer 119 is used to determine whether position and/or speed reported by the vehicle units(s) 110 and/or onboard GPS receiver(s) 114 is trusted. In some embodiments, each vehicle unit 110 and/or onboard GPS receiver 114 is assigned a status of healthy or unhealthy (or trusted or untrusted) by the onboard gateway 111 and/or position computer 119. In some embodiments, the onboard gateway 111 and/or position computer 119 performs supervision by performing one or more of the following five checks:
1. The base station 150 that the vehicle units(s) 110 and/or onboard GPS receiver(s) 114 will use to determine position and/or speed has a status of ‘healthy’ (or ‘trusted’) (indicated in (a) in FIG. 3). In some embodiments, this check is true if the management center 130 trusts the speed and position reported by the base station 150, as described above in connection with FIG. 2.
2. The speed reported by the vehicle units(s) 110 and/or onboard GPS receiver(s) 114 is consistent (within a defined tolerance) with a speed reported to the onboard gateway 111 and/or position computer 119 by an onboard, non-GPS speed measurement device such as an IMU (indicated in (b) in FIG. 3).
3. The position reported by the vehicle units(s) 110 and/or onboard GPS receiver(s) 114 is consistent (within a defined tolerance) with the spline of the tracks 105 on a map (indicated in (c) in FIG. 3). Aspects of this check are described in further detail below in connection with FIG. 4.
4. The position reported by the vehicle units(s) 110 and/or onboard GPS receiver(s) 114 is consistent (within a defined tolerance) with a previous position in consideration of the speed of the vehicle 103, direction of travel of the vehicle 103, and time (indicated in (d) in FIG. 3).
5. Upon cold start and/or after predetermined periods (e.g., every hour), a difference in positions reported by the two independent vehicle units 110 and/or onboard GPS receivers 114 in the first vehicle unit 110_1 and the second vehicle unit 110_2 are consistent (within a defined tolerance) with the known separation distance/between the associated onboard GPS antennas 116_1 and 116_2 (indicated in (e) in FIG. 3).

In some embodiments, the onboard gateway 111 and/or position computer 119 trusts (e.g., utilize for vehicle control) the position and speed reported by the vehicle units(s) 110 and/or onboard GPS receiver(s) 114 if one or more of the above five checks are true. In some embodiments, the onboard gateway 111 and/or position computer 119 trust the position and speed reported by the vehicle unit(s) 110 and/or onboard GPS receivers 114 only if all five of the above five checks are true.

Aspects of the above third check (consistency with map) will now be described in further detail.

FIG. 4 is a schematic diagram of supervision of position reported by an onboard GPS receiver using a map, in accordance with some embodiments.

FIG. 4 shows a portion of a map 400. In some embodiments, the map 400 is stored in a database. The map 400 includes a map spline 410. A vehicle, e.g., the vehicle 103, moves on the map spline 410. In some embodiments, the map spline 410 represents an actual or true path of the vehicle 103. In some embodiments, the map spline 410 is established by other than the positioning system 125, e.g., the map spline 410 is established by survey (i.e., land survey). In some embodiments, the vehicle 103 is a train or other rail vehicle that travels on a pair of uniformly spaced-apart rails, and the map spline 410 represents a centerline between the two rails.

The map 400 also includes an envelope 420 representing a distance or bounding region. In some embodiments, edges of the envelope 420 are a predetermined distance from the map spline 410. In some embodiments, the map 400 is a three-dimensional (3D) map, and the map spline 410 and the envelope 420 have coordinates in three dimensions. In some embodiments, coordinates of the map 400 are expressed in a database using earth-centered earth-fixed (ECEF) data.

In some embodiments, the onboard gateway 111 and/or position computer 119 checks whether the position reported by vehicle unit(s) 110 and/or onboard GPS receiver(s) 114 is consistent (within a defined tolerance) with the map spline 410. In some embodiments, the onboard gateway 111 and/or position computer 119 trusts the position reported by the vehicle unit(s) 110 and/or onboard GPS receiver(s) 114 only if the position reported by the onboard GPS receiver 114 is consistent (within a defined tolerance) with the map spline 410. In some embodiments, the onboard gateway 111 and/or position computer 119 assigns a status of ‘healthy’ (or ‘trusted’) to the vehicle unit(s) 110 and/or onboard GPS receiver(s) 114 only if the position reported by the onboard GPS receiver 114 is consistent (within a defined tolerance) with the map spline 410. In some embodiments, the onboard gateway 111 and/or position computer 119 runs a position function that accepts the resolved position from the vehicle unit(s) 110 and/or onboard GPS receiver(s) 114 only if the vehicle unit(s) 110 and/or onboard GPS receiver(s) 114 provides a position that is within the envelope 420.

For example, in FIG. 4, POS4 is an actual, true position of the vehicle 103 on the map. POS4_0 is a position that is outside of the envelope 420. That is, POS4_0 is not consistent (within a defined tolerance) with the map spline 410. POS4_1 is a position that is inside the envelope 420. That is, POS4_1 is consistent (within a defined tolerance) with the map spline 410. In this example, the onboard gateway 111 and/or position computer 119 trusts the position reported by the vehicle unit(s) 110 and/or onboard GPS receiver(s) 114 if the position reported by the onboard GPS receiver 114 is POS4_1, whereas the onboard gateway 111 and/or position computer 119 does not trust the position reported by the vehicle unit(s) 110 and/or onboard GPS receiver(s) 114 if the position reported by the onboard GPS receiver 114 is POS4_0.

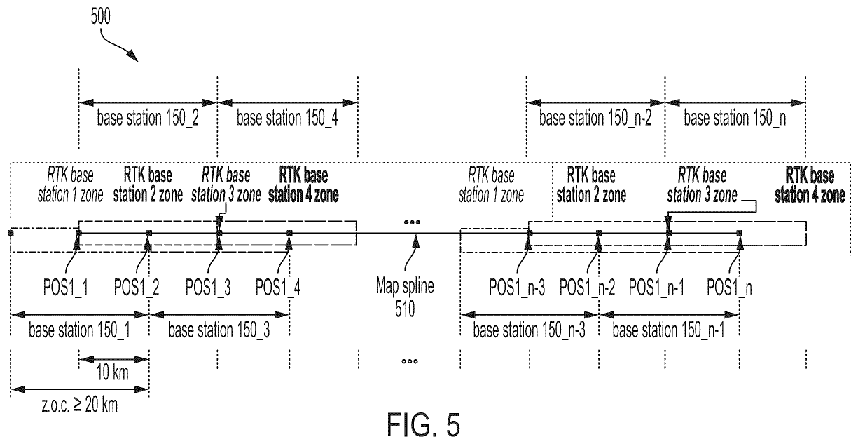

FIG. 5 is a schematic diagram of an arrangement 500 of redundant base stations, in accordance with some embodiments.

In FIG. 5, the arrangement 500 of redundant base stations includes a number ‘n’ of base stations placed along a map spline 510, shown as base stations 150_1, 150_2, 150_3, 150_4, . . . , 150_n-3, 150_n-2, 150_n-1, and 150_n. In FIG. 5, base station 150_1 is at position POS1_1, base station 150_2 is at position POS1_2, base station 150_3 is at position POS1_3, base station 150_4 is at position POS1_4, base station 150_n-3 is at position POS1_n-3, base station 150_n-2 is at position POS1_n-2, base station 150_n-1 is at position POS1_n-1, and base station 150_n is at position POS1_n. In some embodiments, the positions POS1_1, . . . , POS1_n are established by other than the positioning system 125, e.g., the positions POS1_1, . . . , POS1_n are established by survey (i.e., land survey) during initial base station installation. In some embodiments, the base stations positions (e.g., the positions POS1_1, . . . , POS1_n) are stored in a map or database.

In some embodiments, the base stations 150 are placed at regular intervals along the map spline 510, with the intervals representing one-half or less than one-half of a zone of coverage provided by each base station 150. In some embodiments, the base stations 150 are placed at intervals that are not regular. In some embodiments, each point along the map spline 510 is within a zone of coverage of at least two base stations 150. In some embodiments, some sections of the map spline 510 are within a zone of coverage of two base stations 150 while other sections of the map spline 510 are with a zone of coverage of a single base station 150 or more than two base stations 150.

In one example, shown in FIG. 5, a zone of coverage of each base station is at least 20 km, and the base stations are placed at intervals of 10 km, e.g., a distance between position POS1_1 and POS1_2 is 10 km. In another example, a zone of coverage of each base station is at least 40 km, and the base stations are placed at intervals of 20 km. In other examples, the base stations 150 have zones of coverage (z.o.c.) that are greater than 40 km or less than 20 km. In other examples, the base stations 150 are placed at intervals that are greater than 20 km or less than 10 km.

FIG. 5 shows the positions POS1_1, . . . , POS1_n being on the map spline 510. However, in some embodiments, the base stations 150 are placed remote to the map spline 510 while still encompassing the map spline 510 within the zone of coverage of the base stations 150.

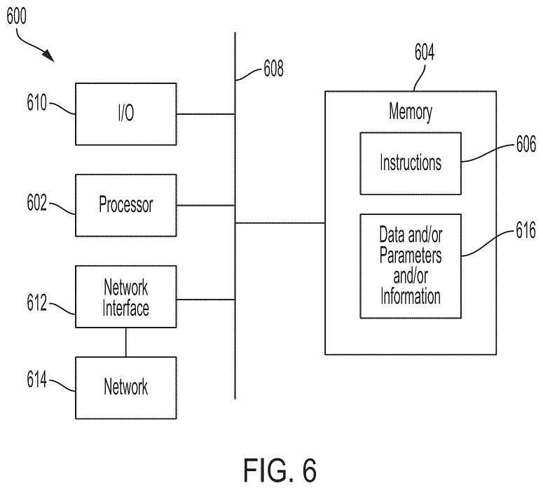

FIG. 6 is a block diagram of a processing system 600 in accordance with some embodiments.

In some embodiments, the processing system 600 is a general purpose computing device including a hardware processor 602 and a non-transitory, computer-readable storage medium 604. The computer-readable storage medium 604, amongst other things, is encoded with, i.e., stores, computer program code 606, i.e., a set of executable instructions. Execution of instructions 606 by the processor 602 represents (at least in part) a tool which implements a portion or all of the methods described herein in accordance with one or more embodiments (hereinafter, the noted processes and/or methods).

The processor 602 is electrically coupled to the computer-readable storage medium 604 via a bus 608. The processor 602 is also electrically coupled to an I/O interface 610 by the bus 608. A network interface 612 is also electrically connected to the processor 602 via the bus 608. Network interface 612 is connected to a network 614, so that the processor 602 and the computer-readable storage medium 604 are capable of connecting to external elements via the network 614. The processor 602 is configured to execute computer program code 606 encoded in the computer-readable storage medium 604 in order to cause the processing system 600 to be usable for performing a portion or all of the noted processes and/or methods. In one or more embodiments, the processor 602 is a central processing unit (CPU), a multi-processor, a distributed processing system, an application specific integrated circuit (ASIC), and/or a suitable processing unit.

In one or more embodiments, the computer-readable storage medium 604 is an electronic, magnetic, optical, electromagnetic, infrared, and/or a semiconductor system (or apparatus or device). For example, the computer-readable storage medium 604 includes a semiconductor or solid-state memory, a magnetic tape, a removable computer diskette, a random access memory (RAM), a read-only memory (ROM), a rigid magnetic disk, and/or an optical disk. In one or more embodiments using optical disks, the computer-readable storage medium 604 includes a compact disk-read only memory (CD-ROM), a compact disk-read/write (CD-R/W), and/or a digital video disc (DVD).

In one or more embodiments, the computer-readable storage medium 604 stores computer program code 606 configured to cause the processing system 600 (where such execution represents (at least in part) the EDA tool) to be usable for performing a portion or all of the noted processes and/or methods. In one or more embodiments, the computer-readable storage medium 604 also stores information including data and/or parameters and/or information 616 which facilitates performing a portion or all of the noted processes and/or methods.

The processing system 600 includes I/O interface 610. I/O interface 610 is coupled to external circuitry. In one or more embodiments, I/O interface 610 includes a keyboard, keypad, mouse, trackball, trackpad, touchscreen, and/or cursor direction keys for communicating information and commands to the processor 602.

The processing system 600 also includes network interface 612 coupled to the processor 602. Network interface 612 allows the processing system 600 to communicate with the network 614, to which one or more other computer systems are connected. Network interface 612 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more processing systems 600.

The processing system 600 is configured to receive information through I/O interface 610. The information received through I/O interface 610 includes one or more of instructions, data, design rules, libraries of standard cells, and/or other parameters for processing by the processor 602. The information is transferred to the processor 602 via the bus 608. The processing system 600 is configured to receive information related to a user interface (UI) through I/O interface 610. The information is stored in the computer-readable storage medium 604 as a UI 642.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, a portion or all of the noted processes and/or methods is implemented as a software application that is used by the processing system 600.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

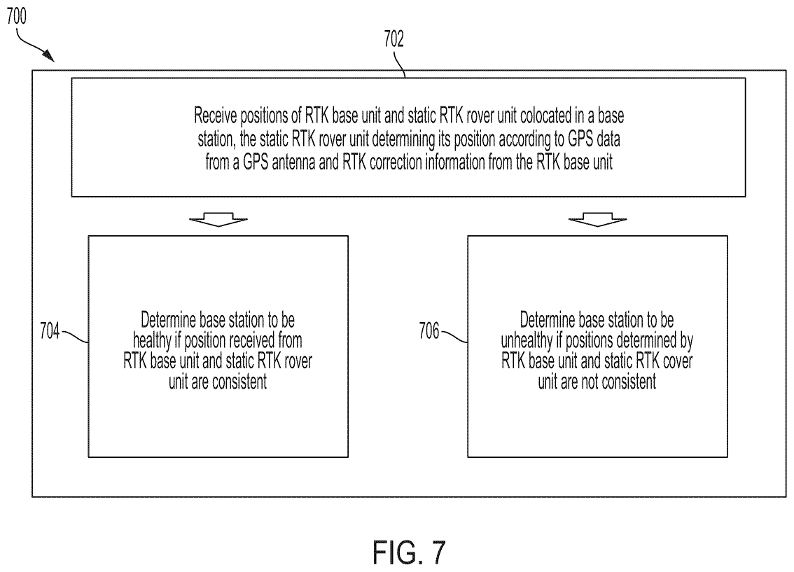

FIG. 7 is a flowchart of a method 700 of determining vehicle position, in accordance with some embodiments.

In FIG. 7, the method 700 includes operations 702, 704, and 706.

In operation 702, positions of RTK base unit and static RTK rover unit collocated in a base station are received. In some embodiments, the positions are received by the management center 130 described above. The static RTK rover unit determining its position according to GPS data from a GPS antenna coupled to the base station and RTK correction information received from the RTK base unit.

In operation 704, the base station is determined to be healthy if the positions received from the RTK base unit and the static RTK rover unit are consistent within a defined tolerance. In some embodiments, the positions are compared for consistency in the management center 130.

In operation 706, the base station is determined to be unhealthy if the positions received from the RTK base unit and the static RTK rover unit are not consistent within the defined tolerance. In some embodiments, the positions are compared for consistency in the management center 130.

In some embodiments, the determination of healthy or unhealthy is made by the management center 130.

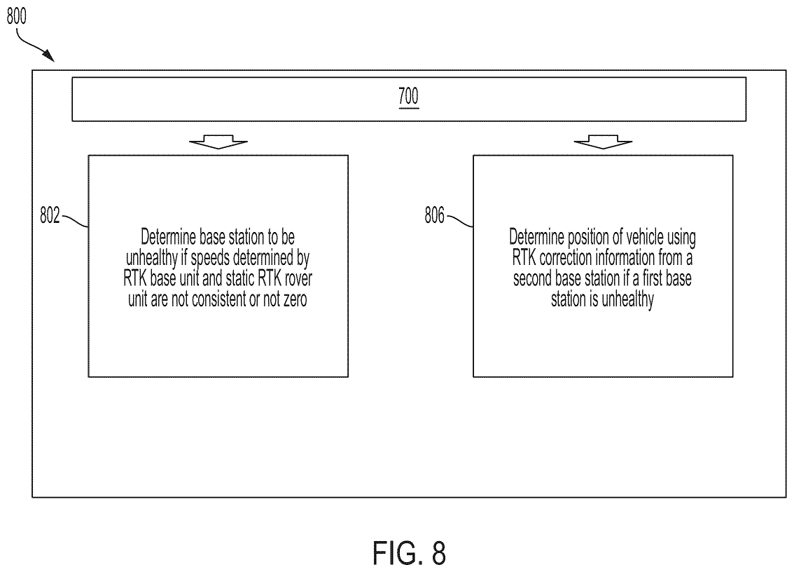

FIG. 8 is a flowchart of a method 800 of determining vehicle position, in accordance with some embodiments.

In FIG. 8, the method 800 includes operations 802 and 804 that follow the method 700.

In operation 802, the base station is determined to be unhealthy if speeds determined by RTK base unit and static RTK rover unit are not consistent within a defined tolerance or not zero within a defined tolerance. In some embodiments, the speeds are compared for consistency and/or compared to zero in the management center 130.

In operation 804, a position of a vehicle is determined using RTK correction information from a second base station if a first base station is determined to be unhealthy. In some embodiments, the management center 130 controls whether the position of the vehicle is determined using the first base station or the second base station.

### Acronyms and Terms

CBTC: communication based train control
DTLS: datagram transport layer security
ECEF: earth-centered earth-fixed
GNSS: global navigation satellite system
GPS: global positioning system, a type of GNSS
IPSec: internet protocol security
KPI: key performance indicator
RTK: real-time kinematic
TAP: Thales Autonomy Platform
SSH: secure shell
TLS: transport layer security
TTDP: train topology discovery protocol
UWB: ultra-wideband
VM: virtual machine
VPN: virtual private network
VSWR: voltage standing wave ratio
NETCONF: a protocol defined by the Internet Engineering Task Force (IETF) to install, manipulate, and delete a configuration of a network device.
OpenVPN: a VPN system that implements techniques to create secure point-to-point or site-to-site connections in routed or bridged configurations and remote access facilities.
WireGuard: a communication protocol that implements encrypted VPNs.

Systems and methods according to some embodiments are operable to place a vehicle in unique global coordinates (e.g., latitude, longitude, and altitude) with high positioning integrity, which is not possible using localization approaches that rely on locating the vehicle relative to surrounding features such as those that are detectable by camera, radar, lidar (light detection and ranging), or the like. As such, systems and methods according to some embodiments can help to ensure that a position derived for a vehicle is the only possible position for the vehicle on a map. Systems and methods according to some embodiments are operable to place a vehicle in a position that is accurate within centimeters, e.g., 10 cm or better, and are usable in vehicle positioning such as establishing a position of the vehicle on a specific track among a plurality of adjacent tracks, train-to-platform positioning that calls for accuracy on the order of approximately 30 cm, or the like. In some embodiments, base station redundancy is provided with relatively few elements, e.g., relatively few base stations as compared to a number of wayside elements such as UWB or other dedicated or purpose-made wayside elements that would be used to provide equivalent positioning accuracy.

In some embodiments, a system includes a base station that includes an RTK base unit and a static RTK rover unit, the RTK base unit and the static RTK rover unit being at a same fixed location; a GPS antenna corresponding to the base station and being at a first position; and a management center in communication with the base station. The RTK base unit includes a first GPS receiver coupled to the GPS antenna, the static RTK rover unit includes a second GPS receiver coupled to the GPS antenna, the static RTK rover unit is configured to determine its position as a second position according to GPS information received via the GPS antenna and RTK correction information received from the RTK base unit, and the management center is configured to determine whether the RTK correction information is valid.

In some embodiments, at least one of the base station and the management center is configured to compare the first position and the second position. In some embodiments, the management center determines the RTK correction information to be invalid when the first position and the second position differ by more than a defined tolerance. In some embodiments, the management center determines the RTK correction information to be invalid when the first position and the second position differ by more than about 10 cm. In some embodiments, the RTK base unit is configured to determine its speed as a first speed, and the static RTK rover unit is configured to determine its speed as a second speed. In some embodiments, at least one of the base station and the management center is configured to compare the first speed and the second speed. In some embodiments, the management center determines the RTK correction information to be invalid when the first speed differs from the second speed by more than a defined tolerance. In some embodiments, the management center determines the RTK correction information to be invalid when the first speed differs from the second speed by more than about 2 cm/second. In some embodiments, the management center determines the RTK correction information to be invalid when either of the first speed or the second speed is greater than zero by more than a defined tolerance. In some embodiments, the first position is determined by other than the base station.

In some embodiments, a system includes a base station that includes an RTK base unit and a static RTK rover unit, the RTK base unit and the static RTK rover unit being at a same fixed location along a track; a GPS antenna corresponding to the base station and being at a first position; a management center in communication with the base station; and a vehicle that includes a mobile RTK rover unit and is movable along the track. The RTK base unit includes a first GPS receiver coupled to the GPS antenna, the static RTK rover unit includes a second GPS receiver coupled to the GPS antenna, the mobile RTK rover unit includes a third GPS receiver, the static RTK rover unit is configured to determine its position as a second position according to GPS information received via the GPS antenna and RTK correction information received from the RTK base unit, and the management center is configured to determine, based on a comparison of the first and second positions, whether the RTK correction information is used by the mobile RTK rover unit to determine a position of the vehicle.

In some embodiments, the base station is a first base station at a first location, and the system further comprises a second base station at a second location different from the first location, the mobile RTK rover unit is configured to receive first RTK correction information from the first base station, and receive second RTK correction information from the second base station, and the mobile RTK rover unit is configured to use the second RTK correction information to determine the position of the vehicle when the management center determines that the first RTK correction information is invalid. In some embodiments, the mobile RTK rover unit is configured to receive first RTK correction information from the first base station, and receive second RTK correction information from the second base station, and the mobile RTK rover unit is configured to use the second RTK correction information to determine the position of the vehicle when the management center determines that the first RTK correction information is invalid. In some embodiments, the system further includes a map, the mobile RTK rover unit is configured to determine the position of the vehicle as a third position, and the management center is configured to compare the third position to the map. In some embodiments, the management center is configured to determine that the third position is invalid if the third position differs from a spline of the map by more than a defined tolerance. In some embodiments, the base station is a first base station at a first location, and the system further comprises a second base station at a second location and a third base station at a third location, the second location being between the first and third locations, the map has a spline section that is covered by a zone of coverage of the second base station, and the entire spline section is also covered by a zone of coverage of at least one of the first and third base stations.

In some embodiments, a method includes receiving positions of an RTK base unit and a static RTK rover unit collocated with the RTK base unit in a base station, wherein the static RTK rover unit is configured to determine its position according to GPS data received from a GPS antenna and RTK correction information received from the RTK base unit; determining the base station to be healthy if the positions determined by the RTK base unit and the static RTK rover unit are consistent within a defined tolerance; and determining the base station to be unhealthy if the positions determined by the RTK base unit and the static RTK rover unit are not consistent within the defined tolerance.

In some embodiments, the method further includes determining the base station to be unhealthy if speeds determined by the RTK base unit and the static RTK rover unit are not consistent within a defined tolerance. In some embodiments, the method further includes determining the base station to be unhealthy if either of a speed determined by the RTK base unit or a speed determined by the static RTK rover unit is not zero within a defined tolerance. In some embodiments, the base station is a first base station at a first location, and a second base station is at a second location from the first location, and the method further includes determining a position of a vehicle using RTK correction information received from the second base station if the first base station is determined to be unhealthy.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system comprising:
a base station that includes an RTK base unit and a static RTK rover unit, the RTK base unit and the static RTK rover unit being at a same fixed location;
a GPS antenna corresponding to the base station and being at a first position; and
a management center in communication with the base station, wherein:
the RTK base unit includes a first GPS receiver coupled to the GPS antenna,
the static RTK rover unit includes a second GPS receiver coupled to the GPS antenna,
the static RTK rover unit is configured to determine its position as a second position according to GPS information received via the GPS antenna and RTK correction information received from the RTK base unit, and
the management center is configured to determine whether the RTK correction information is valid.

2. The system of claim 1, wherein at least one of the base station and the management center is configured to compare the first position and the second position.

3. The system of claim 2, wherein the management center determines the RTK correction information to be invalid when the first position and the second position differ by more than a defined tolerance.

4. The system of claim 2, wherein the management center determines the RTK correction information to be invalid when the first position and the second position differ by more than about 10 cm.

5. The system of claim 1, wherein:
the RTK base unit is configured to determine its speed as a first speed, and
the static RTK rover unit is configured to determine its speed as a second speed.

6. The system of claim 5, wherein at least one of the base station and the management center is configured to compare the first speed and the second speed.

7. The system of claim 6, wherein the management center determines the RTK correction information to be invalid when the first speed differs from the second speed by more than a defined tolerance.

8. The system of claim 6, wherein the management center determines the RTK correction information to be invalid when the first speed differs from the second speed by more than about 2 cm/second.

9. The system of claim 6, wherein the management center determines the RTK correction information to be invalid when either of the first speed or the second speed is greater than zero by more than a defined tolerance.

10. The system of claim 1, wherein the first position is determined by other than the base station.

11. A system comprising:
a base station that includes an RTK base unit and a static RTK rover unit, the RTK base unit and the static RTK rover unit being at a same fixed location along a track;
a GPS antenna corresponding to the base station and being at a first position;
a management center in communication with the base station; and
a vehicle that includes a mobile RTK rover unit and is movable along the track, wherein:
the RTK base unit includes a first GPS receiver coupled to the GPS antenna,
the static RTK rover unit includes a second GPS receiver coupled to the GPS antenna,
the mobile RTK rover unit includes a third GPS receiver,
the static RTK rover unit is configured to determine its position as a second position according to GPS information received via the GPS antenna and RTK correction information received from the RTK base unit, and
the management center is configured to determine, based on a comparison of the first and second positions, whether the RTK correction information is used by the mobile RTK rover unit to determine a position of the vehicle.

12. The system of claim 11, wherein:
the base station is a first base station at a first location, and the system further comprises a second base station at a second location different from the first location,
the mobile RTK rover unit is configured to receive first RTK correction information from the first base station, and receive second RTK correction information from the second base station, and
the mobile RTK rover unit is configured to use the second RTK correction information to determine the position of the vehicle when the management center determines that the first RTK correction information is invalid.

13. The system of claim 12, wherein the mobile RTK rover unit is configured to receive first RTK correction information from the first base station, and receive second RTK correction information from the second base station, and
the mobile RTK rover unit is configured to use the second RTK correction information to determine the position of the vehicle when the management center determines that the first RTK correction information is invalid.

14. The system of claim 11, further comprising a map, wherein:
the mobile RTK rover unit is configured to determine the position of the vehicle as a third position, and
the management center is configured to compare the third position to the map.

15. The system of claim 14, wherein the management center is configured to determine that the third position is invalid if the third position differs from a spline of the map by more than a defined tolerance.

16. The system of claim 14, wherein:
the base station is a first base station at a first location, and the system further comprises a second base station at a second location and a third base station at a third location, the second location being between the first and third locations,
the map has a spline section that is covered by a zone of coverage of the second base station, and
the entire spline section is also covered by a zone of coverage of at least one of the first and third base stations.

17. A method comprising:
receiving positions of an RTK base unit and a static RTK rover unit collocated with the RTK base unit in a base station, the RTK base unit and the static RTK rover unit sharing a same GPS antenna, wherein the static RTK rover unit is configured to determine its position according to GPS data received from the GPS antenna and RTK correction information received from the RTK base unit;
determining the base station to be healthy if the positions determined by the RTK base unit and the static RTK rover unit are consistent within a defined tolerance; and
determining the base station to be unhealthy if the positions determined by the RTK base unit and the static RTK rover unit are not consistent within the defined tolerance.

18. The method of claim 17, further comprising determining the base station to be unhealthy if speeds determined by the RTK base unit and the static RTK rover unit are not consistent within a defined tolerance.

19. The method of claim 17, further comprising determining the base station to be unhealthy if either of a speed determined by the RTK base unit or a speed determined by the static RTK rover unit is not zero within a defined tolerance.

20. The method of claim 17, wherein:
the base station is a first base station at a first location, and a second base station is at a second location from the first location,
the method further comprising determining a position of a vehicle using RTK correction information received from the second base station if the first base station is determined to be unhealthy.
